(19) United States
(12) Patent Application Publication
(10) Pub. No.: US 2020/0265691 A1
(43) Pub. Date: Aug. 20, 2020

(54) Wireless device capable of indicating a status of a wireless apparatus nearby

(71) Applicant: Gemtek Technology Co., Ltd., Hsinchu (TW)

(72) Inventors: Fu-Ming Yeh, Hsinchu (TW); Yin-Cheng Wang, Hsinchu (TW); Chia-Kang Chao, Hsinchu (TW); Sin-Liang Chen, Hsinchu (TW)

(21) Appl. No.: 16/687,705

(22) Filed: Nov. 19, 2019

Related U.S. Application Data
(60) Provisional application No. 62/807,205, filed on Feb. 18, 2019.

(30) Foreign Application Priority Data
Jul. 25, 2019 (TW) 108126330

(51) Int. Cl. G08B 5/36; H01Q 1/24; H04L 12/26; H04B 17/318; H04W 24/08

(52) U.S. Cl. CPC G08B 5/36; H01Q 1/24; H04W 24/08; H04B 17/318; H04L 43/0894

(57) ABSTRACT

A wireless device has an antenna module, an indicating module, and a control circuit. The antenna module has at least a smart antenna. The indicating module has a plurality of indicating units. The control circuit is coupled to the antenna module and the indicating units for determining at least a parameter between the wireless device and at least a wireless apparatus according to radio signals received from the at least a wireless apparatus via the antenna module, and for controlling operations of the indicating units according to the at least a parameter.

### CROSS REFERENCE TO RELATED APPLICATIONS

This non-provisional application claims priority of U.S. provisional application No. 62/807,205, filed on Feb. 18, 2019, and Taiwan patent application No. 108126330, filed on Jul. 25, 2019, included herein by reference in their entirety.

### BACKGROUND OF THE INVENTION

### 1. Field of the Invention

The present invention relates to a wireless device, and more particularly to a wireless device with a smart antenna.

### 2. Description of the Prior Art

With the rapid development of wireless communications requirements and the rapid increase of multimedia information exchange, the next generation of wireless communications technology must meet the needs of high-speed, high-quality, and high-capacity. In this consideration, smart antenna technology is an effective way to meet the needs of the next generation of wireless communications. Moreover, how to improve the user experience of wireless devices having smart antennas is one of the important issues in the field.

### SUMMARY OF THE INVENTION

An embodiment of the present invention provides a wireless device, which comprises an antenna module, an indicating module and a control circuit. The antenna module comprises at least a smart antenna. The indicating module comprises a plurality of indicating units. The control circuit is coupled to the antenna module and the indicating units for determining at least a parameter between the wireless device and at least a wireless apparatus according to radio signals received by the antenna module from the at least a wireless apparatus and for controlling operations of the indicating units according to the at least a parameter.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a wireless device according to an embodiment of the present invention.

FIG. 2 is a perspective view of a wireless device according to another embodiment of the present invention.

FIG. 3 is a top view of the wireless device in FIG. 2.

FIG. 4 is a flow chart for controlling the wireless device in FIG. 1 according to an embodiment of the present invention.

FIG. 5 is a simplified schematic diagram of the wireless device in FIG. 1.

FIG. 6 is a schematic diagram of the wireless device in FIG. 1 when the wireless device wirelessly communicates with a client.

FIG. 7 is a schematic diagram of the wireless device in FIG. 1 when the wireless device wirelessly communicates with two clients.

FIG. 8 is a schematic diagram of two wireless devices wirelessly communicating with each other according to an embodiment of the present invention.

FIG. 9 is a schematic diagram of three wireless devices communicating with each other according to an embodiment of the present invention.

FIG. 10 is a schematic diagram of three wireless devices and four clients communicating with each other according to an embodiment of the present invention.

FIGS. 11 and 12 are diagrams for explaining how the control circuit in FIG. 1 controls the brightness of the indicating units of the indicating module according to the intensity of the radio signal between the wireless device and the client.

### DETAILED DESCRIPTION

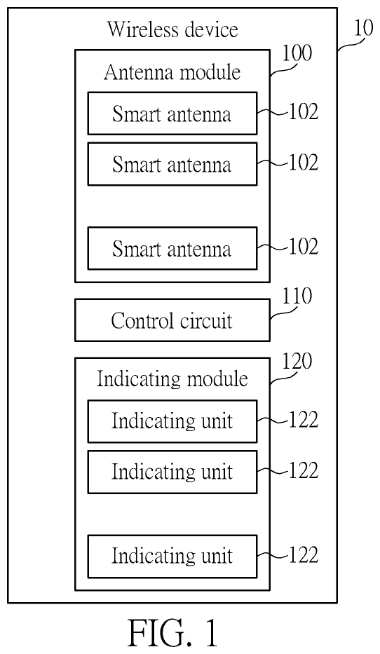

FIG. 1 is a functional block diagram of a wireless device 10 according to an embodiment of the present invention. The wireless device 10 comprises an antenna module 100, an indicating module 120, and a control circuit 110. The antenna module 100 comprises at least a smart antenna 102 for receiving and transmitting radio signals for wirelessly communicating with other wireless apparatuses. The antenna module 100 may comprise a single smart antenna 102 or a plurality of smart antennas 102.

The indicating module 120 comprises a plurality of indicating units 122. In the embodiment, each indicating unit 122 may be a light emitting diode (LED). In addition, the control circuit 110 is coupled to the antenna module 100 and the indicating units 122 for determining at least a parameter between the wireless device 10 and at least a wireless apparatus (e.g., a mobile phone, another wireless device 10, a notebook computer, etc.) according to radio signals received by the antenna module 100 from the at least a wireless apparatus. The at least a parameter may comprise, but is not limited thereto, an orientation of the at least a wireless apparatus relative to the wireless device 10, intensities of the radio signals received by the antenna module 100 from the at least a wireless apparatus, data transmission rate between the wireless device 10 and the at least a wireless apparatus, a distance between the wireless device 10 and the at least a wireless apparatus, and the like. The control circuit 110 may control the operations of the indicating units 122 according to the at least a parameter. For example, the control circuit 110 determines the orientation from the wireless device 10 to the at least a wireless apparatus and controls some of the indicating units 122 to emit light so as to indicate the orientation of the at least a wireless apparatus relative to the wireless device 10.

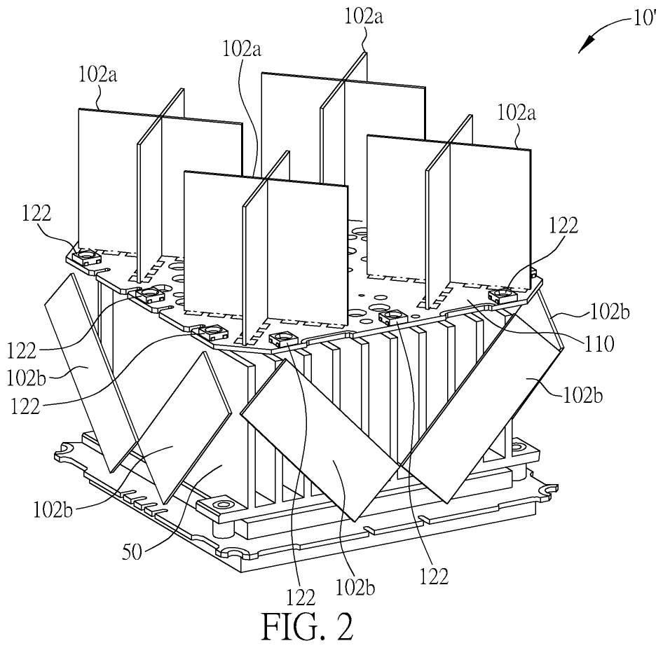

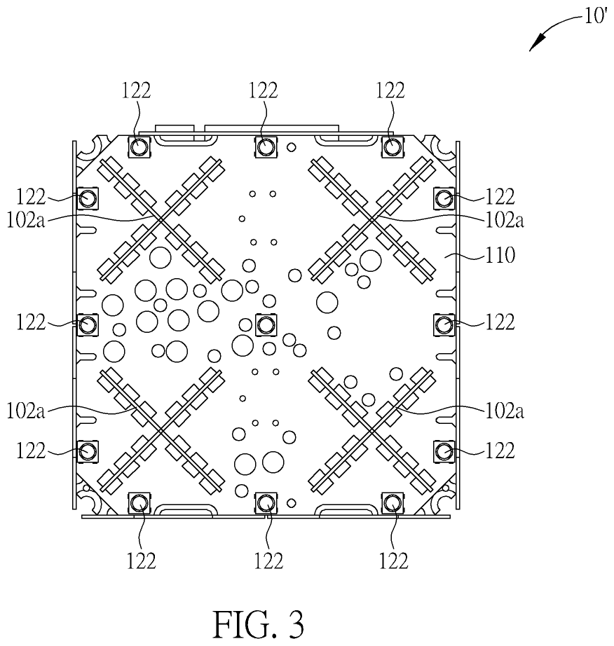

FIG. 2 is a perspective view of a wireless device 10′ according to another embodiment of the present invention, and FIG. 3 is a top view of the wireless device 10′ in FIG. 2. The wireless device 10′ may comprise all of the components of the wireless device 10 in FIG. 1 and further comprises a chassis 50. Components of the wireless device 10 may be disposed directly or indirectly on the chassis 50. In this embodiment, the wireless device 10′ may comprise four first smart antennas 102a and eight second smart antennas 102b. The chassis 50 may comprise four sides, and there are two second smart antennas 102b mounted on each side of the chassis 50. In addition, each of the first smart antennas 102a may operate in a frequency band of 5 GHz, and each of the second smart antennas 102b may operate in a frequency band of 2.4 GHz. The number of the first smart antennas 102a, the number of the second smart antennas 102b, and the operating frequency bands of the first smart antennas 102a and the second smart antennas 102b are merely exemplary, and the invention is not limited thereto. The wireless device 10′ may have different numbers of the first smart antenna 102a and the second smart antenna 102b, and the first smart antenna 102a and the second smart antenna 102b may operate in frequency bands different from 5 GHz and 2.4 GHz respectively. Moreover, in other embodiments, the wireless device 10′ may comprise only the first smart antennas 102a but not the second smart antennas 102b. In some embodiments of the present invention, the wireless device 10′ may comprise only the second smart antennas 102b but not the first smart antennas 102a.

The control circuit 110 of the wireless device 10′ may be a circuit board disposed on the chassis 50, and the first smart antennas 102a and the indicating units 122 of the indicating module 120 are disposed on the circuit board. In the embodiment, the indicating module 120 may have twelve indicating units 122, and each of the indicating units 122 may be a light-emitting diode. The number of indicating units 122 of the indicating module 120 is not limited to twelve, but may be other numbers greater than one. The operations of the antenna module 100, the indicating module 120 and the control circuit 110 of the wireless device 10′ are the same as those of the wireless device 10 in FIG. 1. Therefore, it will not be repeated herein.

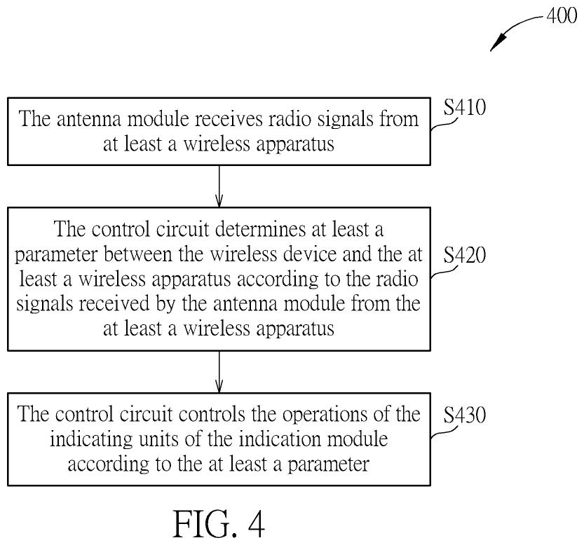

Please refer to FIG. 4. FIG. 4 is a flow chart of a method 400 for controlling the wireless device 10 in FIG. 1 according to an embodiment of the present invention. The method 400 comprises the following steps:

Step S410: The antenna module 100 receives radio signals from at least a wireless apparatus;

Step S420: The control circuit 110 determines at least a parameter between the wireless device 10 and the at least a wireless apparatus according to the radio signals received by the antenna module 100 from the at least a wireless apparatus; and

Step S430: The control circuit 110 controls the operations of the indicating units 122 of the indicating module 120 according to the at least a parameter.

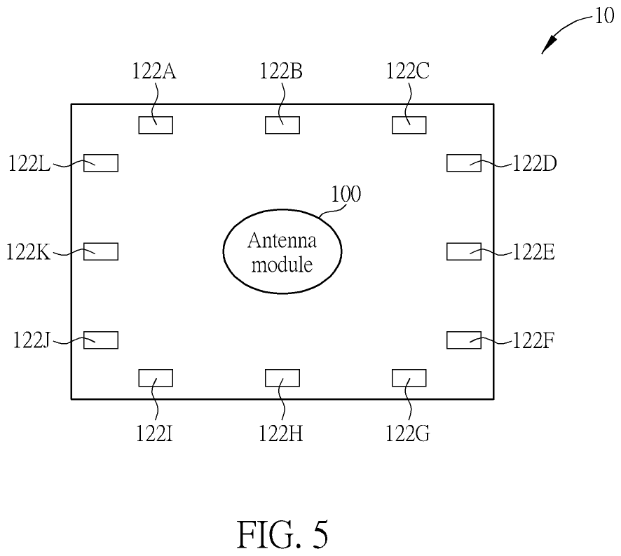

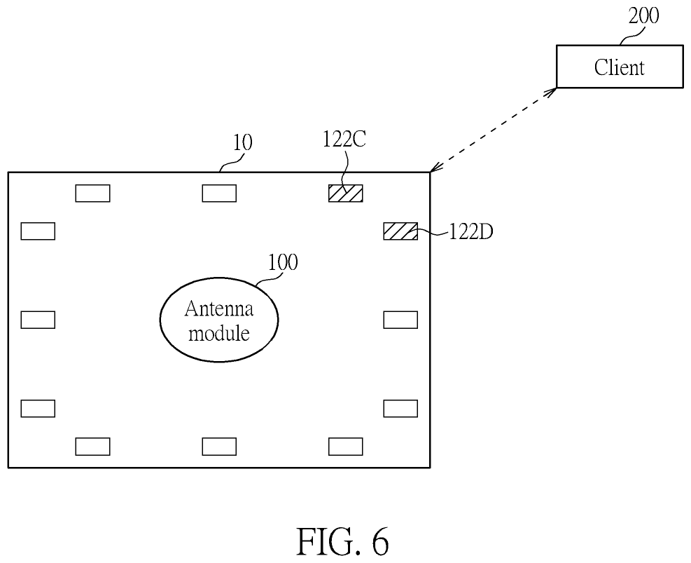

The wireless device 10 in FIG. 1 may be simplified as shown in FIG. 5. The plurality of indicating units 122 of the indicating module 120 are respectively labeled as 122A to 122L to distinguish the indicating units 122. FIG. 6 is a schematic diagram of the wireless device 10 in FIG. 1 when the wireless device 10 wirelessly communicates with a client 200. The client 200 can be a mobile phone, a notebook computer, etc., which is capable of establishing a wireless connection with the wireless device 10. The wireless device 10 can be additionally connected to Internet or other network system, and the client 200 can be connected to Internet or other network system via the wireless device 10. In the embodiment, the control circuit 110 can determine the orientation of the client 200 relative to the wireless device 10 by using beam steering, direction of arrival (DOA), and the like. For example, in the embodiment, the client 200 is located upper right to the wireless device 10, the control circuit 110 may control the indicating units 122C and 122D to emit light, and control other indicating units not to emit light. Thus, the orientation of the client 200 relative to the wireless device 10 can be indicated by the illuminated indicating units 122C and 122D.

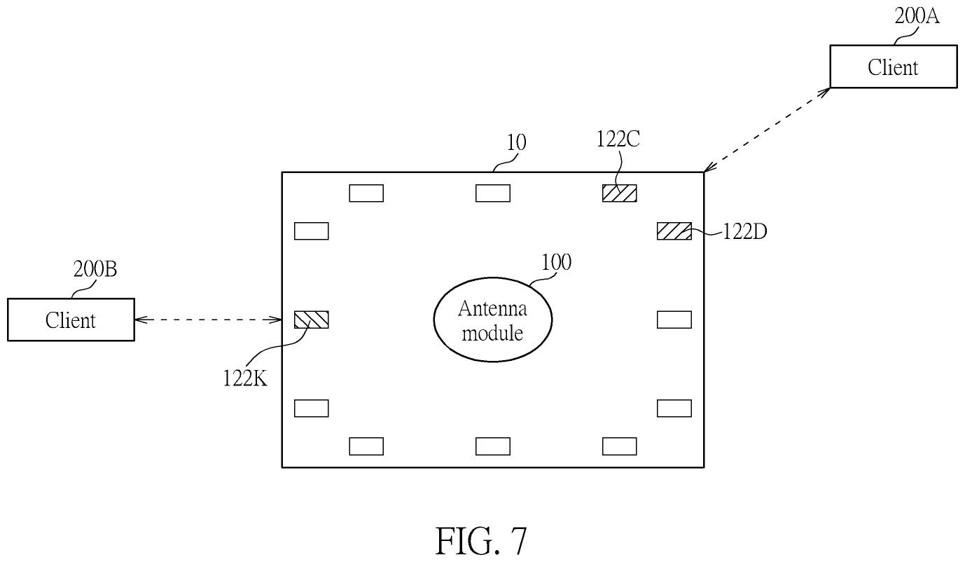

FIG. 7 is a schematic diagram of the wireless device 10 in FIG. 1 when the wireless device 10 wirelessly communicates with two clients 200A and 200B. In this embodiment, the control circuit 110 determines that the client 200A is located upper right to the wireless device 10 and that the client 200B is located left to the wireless device 10 according to the radio signals received by the antenna modules 102 from the two clients 200A and 200B, respectively. Therefore, the control circuit 110 may control the two indicating units 122C and 122D to emit light to indicate orientation of the client 200A and control the indicating unit 122K to emit light to indicate orientation of the client 200B. At this time, other indicating units other than the indicating units 122C, 122D, and 122K may not emit light. In addition, each of the indicating units 122A to 122L is a multi-color LED which can emit light of corresponding colors according to different control signals sent by the control circuit 110. In the present embodiment, the two indicating units 122C and 122D may emit light of the same color to indicate the client 200A, and the indicating unit 122K may emit light of a different color to indicate the client 200B. In this way, the user would easily recognize the number of wireless devices wirelessly connected to the wireless device 10 and their corresponding orientations according to the color(s) of light emitted by the indicating units.

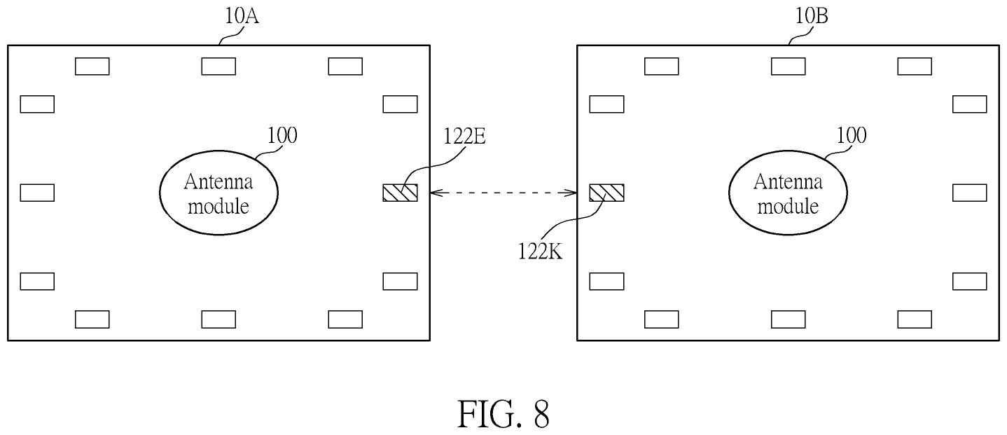

FIG. 8 is a schematic diagram of two wireless devices 10A and 10B wirelessly communicating with each other according to another embodiment. The structure and functions of each of the wireless devices 10A and 10B are similar to those of the wireless device 10 in FIG. 1. Therefore, it will not be repeated herein. In this embodiment, the wireless devices 10A and 10B would detect the orientations relative to each other. The control circuit 110 of the wireless device 10A controls the indicating unit 122E of the wireless device 10A to emit light to indicate the orientation of the wireless device 10B, and causes other indicating units of the wireless device 10A not to emit light. Similarly, the control circuit 110 of the wireless device 10B controls the indicating unit 122K of the wireless device 10B to illuminate to indicate the orientation of the wireless device 10A and causes other indicating units of the wireless device 10B not to emit light.

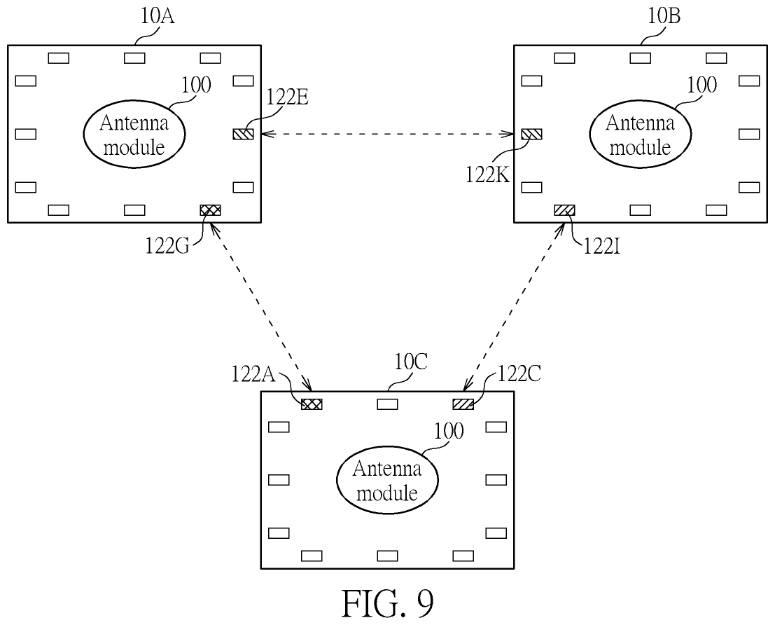

FIG. 9 is a schematic diagram of three wireless devices 10A, 10B and 10C communicating with each other according to another embodiment. The structure and functions of each of the wireless devices 10A, 10B, and 10C are similar to those of the wireless device 10 in FIG. 1. Therefore, it will not be repeated herein. In the embodiment, the wireless devices 10A, 10B, and 10C constitute a mesh network, and can detect the orientations relative to one another. The control circuit 110 of the wireless device 10A controls the indicating units 122E and 122G of the wireless device 10A to emit light to indicate the orientations of the wireless devices 10B and 10C respectively, and causes other indicating units of the wireless device 10A not to emit light. The colors of the light emitted by the indicating units 122E and 122G of the wireless device 10A may be different. Similarly, the control circuit 110 of the wireless device 10B controls the indicating units 122K and 122I of the wireless device 10B to emit light to indicate the orientations of the wireless devices 10A and 10C respectively, and causes other indicating units of the wireless device 10B not to emit light. The colors of the light emitted by the indicating units 122K and 122I of the wireless device 10B may be different. The control circuit 110 of the wireless device 10C controls the indicating units 122A and 122C of the wireless device 10C to emit light to indicate the orientations of the wireless devices 10A and 10B respectively, and causes other indicating units of the wireless device 10C not to emit light. The colors of the light emitted by the indicating units 122A and 122C of the wireless device 10C may be different.

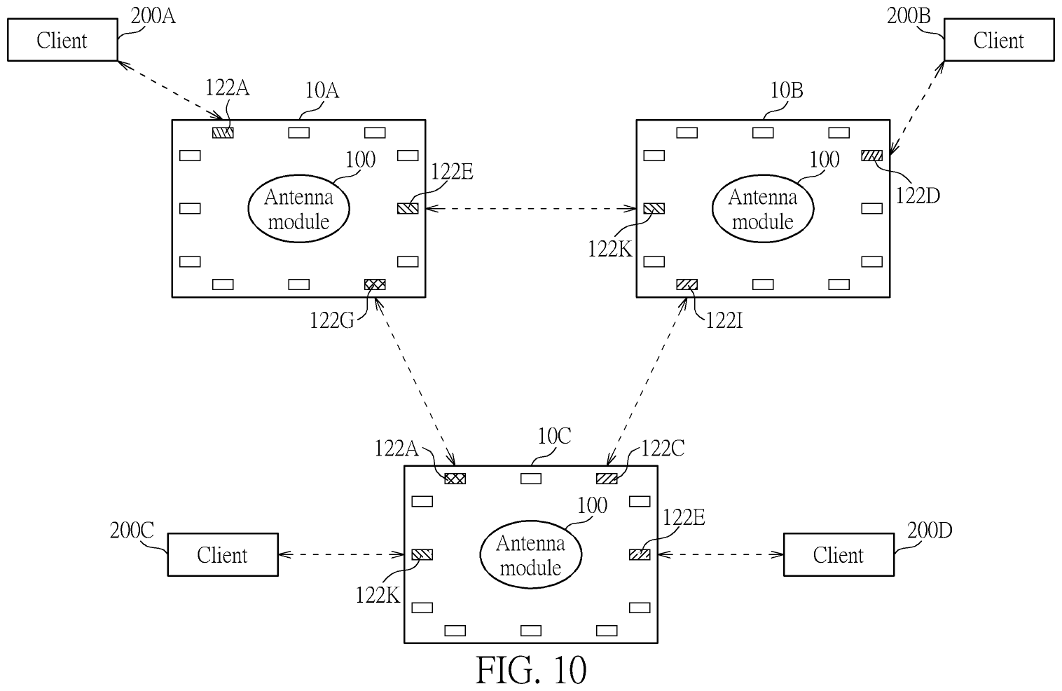

FIG. 10 is a schematic diagram of three wireless devices 10A, 10B and 10C and four clients 200A, 200B, 200C and 200D communicating with each other according to another embodiment. In addition to controls of the indicating units shown in FIG. 9, the wireless device 10A in FIG. 10 further controls the indicating unit 122A of the wireless device 10A to emit light to indicate the orientation of the client 200A relative to the wireless device 10A. The color of the light emitted from the indicating unit 122A may be different from the colors of the light emitted from the indicating units 122E and 122G of wireless device 10A. In addition, the wireless device 10B in FIG. 10 further controls the indicating unit 122D of the wireless device 10B to emit light to indicate the orientation of the client 200B relative to the wireless device 10B, and the color of the light emitted by the indicating unit 122D of the wireless device 10B may be different from the colors of the light emitted from the indicating units 122I and 122K of the wireless device 10B. Furthermore, the wireless device 10C in FIG. 10 further controls the indicating units 122K and 122E of the wireless device 10C to emit light to respectively indicate the orientations of the clients 200C and 200D relative to the wireless device 10C. The colors of the light emitted by the indicating units 122A, 122C, 122E and 122K of the wireless device 10C may be different from one another.

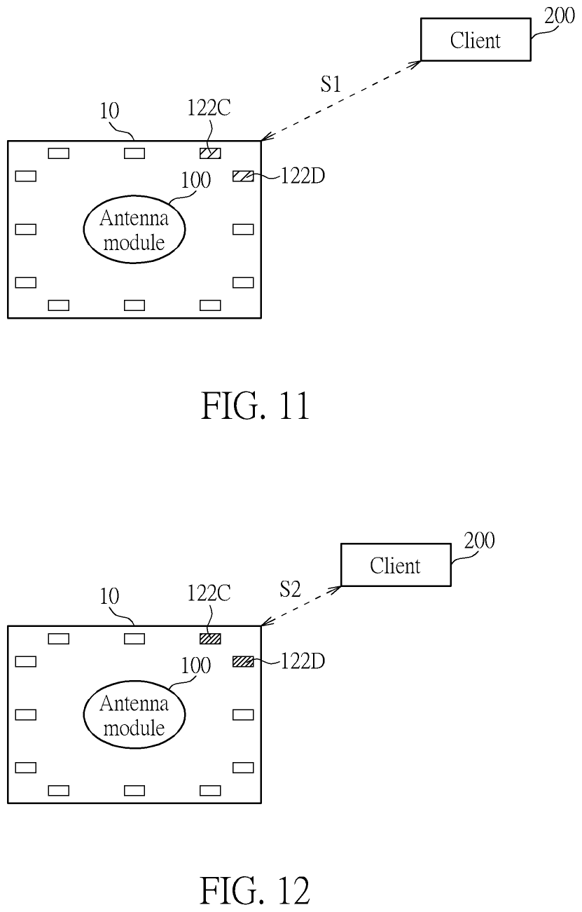

In another embodiment of the present invention, at least one parameter between the wireless device 10 and the at least a wireless apparatus (such as the client 200 or another wireless device 10) determined by the control circuit 110 may comprise intensities of radio signals received by the antenna module 100 from the at least a wireless apparatus. The control circuit 110 may control the brightness of the indicating units 122 according to the intensities of the radio signals. FIGS. 11 and 12 are taken for an example. FIGS. 11 and 12 are diagrams for explaining how the control circuit 110 in FIG. 1 controls the brightness of the indicating units 122 of the indicating module 120 according to the intensities of the radio signals between the wireless device 10 and the client 200. S1 and S2 respectively indicate the intensities of the radio signals between the wireless device 10 and the client 200 in different situations. The intensity S1 of the radio signal between the wireless device 10 and the client 200 in FIG. 11 is smaller than the intensity S2 of the radio signal between the wireless device 10 and the client 200 in FIG. 12. Therefore, the control circuit 110 would control the indicating units 122C and 122D to emit light in FIG. 12 brighter than in FIG. 11.

In another embodiment of the present invention, at least one parameter between the wireless device 10 and the at least a wireless apparatus (such as the client 200 or another wireless device 10) determined by the control circuit 110 may comprise the data transmission rate between the wireless device 10 and the at least a wireless apparatus, and the control circuit 110 may control the brightness of the indicating units 122 according to the data transmission rate. For example, when the data transmission rate is increased, the control circuit 110 increases the brightness of related indicating units 122.

In the above embodiments, the indicating units 122 exemplified by light-emitting diodes, but is not limited thereto. Each of the indicating units 122 may be another component having an indicating function. For example, the indicating module 120 may be a display, and the indicating units 122 may be a plurality of pixels of the display. The display can display a corresponding arrow to indicate the orientation of the wireless apparatus (e.g., the client 200 or another wireless device 10) relative to wireless device 10. The control circuit 110 may also adjust the length of the arrow displayed by the display according to the above parameters such as the distance, the intensity of the radio signal, and the data transmission rate.

In another embodiment, each of the indicating units 122 may be a laser light source for generating a laser beam to indicate the orientation of the wireless apparatus (such as the client 200 or another wireless device 10) relative to the wireless device 10.

In summary, the control circuit of the wireless device in the embodiments of the present invention may determine the at least a parameter between the wireless device and at least a wireless apparatus (such as the client or another wireless device) according to radio signals received by the antenna module from the at least a wireless apparatus and control operations of the indicating units according to the at least a parameter. Controlling the operations of the indicating units may comprise controlling the indicating units to indicate an orientation of the wireless apparatus relative to the wireless device. Thereby, the user would obtain information such as the relative position and the connection state between the wireless device of the present invention and other wireless apparatus by using the indicating units.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A wireless device comprising:
an antenna module comprising at least a smart antenna;
an indicating module comprising a plurality of indicating units; and
a control circuit coupled to the antenna module and the indicating units, configured to determine at least a parameter between the wireless device and at least a wireless apparatus according to radio signals received by the antenna module from the at least a wireless apparatus, and configured to control operations of the indicating units according to the at least a parameter.

2. The wireless device of claim 1, wherein the at least a parameter comprises an orientation of the at least a wireless apparatus relative to the wireless device, and the control circuit controls the indicating units to indicate the orientation.

3. The wireless device of claim 1, wherein the indicating units are a plurality of light-emitting elements, the at least a parameter comprises intensities of the radio signals received by the antenna module from the at least a wireless apparatus, and the control circuit controls brightness of the indicating units according to the intensities.

4. The wireless device of claim 3, wherein each of the light-emitting elements is a light emitting diode.

5. The wireless device of claim 1, wherein the indicating units are a plurality of light-emitting elements, the at least a parameter comprises a data transmission rate between the wireless device and the at least a wireless apparatus, and the control circuit controls brightness of the indicating units according to the data transmission rate.

6. The wireless device of claim 5, wherein each of the light-emitting elements is a light emitting diode.

7. The wireless device of claim 1, wherein the indicating units are a plurality of light-emitting elements, and the control circuit determines the least a parameter between the wireless device and the at least a wireless apparatus according to radio signals received by the antenna module from a plurality of wireless apparatuses and controls operations of the light-emitting elements according to the at least a parameter.

8. The wireless device of claim 7, wherein each of the light-emitting elements is a light emitting diode.

9. The wireless device of claim 1, wherein when a plurality of wireless apparatuses wirelessly communicate with the wireless device, the control circuit controls the indicating units to indicate a plurality of different orientations of the wireless apparatuses relative to the wireless device.

10. The wireless device of claim 9, wherein the control circuit controls the indicating units to emit light of different colors to indicate the plurality of different orientations of the wireless apparatuses relative to the wireless device.

11. The wireless device of claim 1, wherein the indicating module is a display, and the indicating units are a plurality of pixels.

12. The wireless device of claim 1, wherein each of the indicating units is a laser light source.

13. The wireless device of claim 1, further comprising a chassis, wherein the control circuit is a circuit board disposed on the chassis.

14. The wireless device of claim 13, wherein the indicating units are disposed on the circuit board.

15. The wireless device of claim 13, wherein the at least a smart antenna comprises a smart antenna disposed on the circuit board.

16. The wireless device of claim 15, wherein the indicating units are disposed on the circuit board.

17. The wireless device of claim 1, wherein the control circuit is a circuit board, the at least a smart antenna comprises a smart antenna disposed on the circuit board.

18. The wireless device of claim 17, wherein the indicating units are disposed on the circuit board.

19. The wireless device of claim 1, further comprising a chassis, wherein the at least a smart antenna comprises a smart antenna disposed on the chassis.
